(19) United States
(12) Patent Application Publication
(10) Pub. No.: US 2002/0080367 A1
(43) Pub. Date: Jun. 27, 2002

(54) Wavelength measuring apparatus and wavelength tunable light source device with built-in wavelength measuring apparatus

(75) Inventor: Keisuke Asami, Shinshiro-shi (JP)

Correspondence Address: OLIFF & BERRIDGE, PLC, P.O. BOX 19928, ALEXANDRIA, VA, 22320, US

(73) Assignee: ANDO ELECTRIC CO., LTD., Tokyo (JP)

(21) Appl. No.: 10/011,812

(22) Filed: Dec. 11, 2001

(30) Foreign Application Priority Data
Dec. 27, 2000 (JP) 2000-398583

(51) Int. Cl. G01B 9/02

(52) U.S. Cl. 356/519

(57) ABSTRACT

A wavelength measuring apparatus capable of obtaining two signals by a single etalon, and which is physically stable and has high resolution so that direction to which wavelength varies can be recognized in wideband is provided. A Fabry-Perot etalon (etalon) is serves as a wavelength discriminating section of a wavelength measuring apparatus. A beam from an optical fiber passes through a lens generating a collimated beam. An optical branching section splits the collimated beam into two beams and inputs the two beams to the etalon. An optical axis of one split collimated beam is tilted with regard to an optical axis of another one such that each period of amplitude of the split collimated beams relatively shifts in π/2 phase difference. Each first and second photo detectors receives each split collimated beam which has transmitted the etalon, and detects a signal depending on the wavelength.

### BACKGROUND OF THE INVENTION

1. Field of the Invention

The present invention relates to a wavelength measuring apparatus using a Fabry-Perot etalon (hereinafter, it is also simply referred to as “etalon”) for a wavelength discriminating section for monitoring the wavelength of a laser source, such as a semiconductor laser, used in the field of optical communication, and to a wavelength tunable light source device with a built-in such a wavelength measuring apparatus.

2. Description of Related Art

In the field of optical communication, there is wavelength multiplexing communication systems in which information is transmitted by using light with multiplexed wavelengths by use of optical fibers, so that transmission quantity of information is substantially increased, compared to using light with a single wavelength. Recently, in wavelength-division-multiplexing (WDM) systems, information is transmitted simultaneously by a set of laser sources, each generating coherent light with a different wavelength (optical communication channels).

A wavelength measuring apparatus is used for discriminating the wavelength of each laser source in such optical communication systems. In the wavelength measuring apparatus, output beam from an optical fiber is led to a lens, and the lens generates a collimated beam which passes a wavelength discriminating section having wavelength dependency, that is, transmittance or reflectance changes depending on the wavelength. Thereafter, a photo detector (photo diode: PD) detects a signal depending on the wavelength of the beam.

As such wavelength measuring apparatus, there are a WDM coupler type (for example, refer to U.S. Pat. No. 5,822,049, and Japanese Patent Application Laid-open No. Tokukaihei 9-297059), a bandpass filter (BPF) type (for example, refer to Japanese Patent Application Laid-open No. Tokukaihei 10-253452), an interferometer type, and an etalon type (for example, refer to Japanese Patent Application Laid-open No. Tokukaihei 10-339668).

FIG. 7A shows a WDM coupler type wavelength measuring apparatus. The incident beam from a laser source which is not shown is split into optical signals with different wavelengths by a WDM coupler 31. Each of the two split optical signals passes optical fibers 32 and 33, respectively. The light from the optical fibers 32 and 33 are condensed through lenses 34 and 35, and then received in PDs 36 and 37. The PDs 36 and 37 detect the optical signals depending on the wavelengths of light (refer to wavelength-signal intensity characteristics as shown in FIGS. 7B and 7C illustrated on the right of the PDs 36 and 37).

FIG. 8A shows a BPF type wavelength measuring apparatus. The incident light from an optical fiber 41 passes a lens 42 which generates a collimated beam. The collimated beam passes a wavelength discriminating (bandpass) filter (BPF) 43, and then is received by a PD 44. The PD 44 detects an optical signal depending on the wavelength of beam (refer to wavelength-signal intensity characteristics as shown in FIG. 8B illustrated on the right of the PD 44).

FIG. 9A shows an interferometer type wavelength measuring apparatus. The incident light from an optical fiber 51 passes a lens 52 generating a collimated beam which is directed to a beamsplitter 53. The beamsplitter 53 splits the incident beam into a transmitted beam and a reflected beam. The transmitted beam is reflected by a reflecting mirror 54, and then directed to the beamsplitter 53 again. The reflected beam is reflected by a reflecting mirror 55, and then directed to the beamsplitter 53 again. Then, the optical signals are multiplexed by the beamsplitter 53, and then received by a PD 56. The PD 56 detects signals depending on the wavelength (refer to wavelength-signal intensity characteristics as shown in FIG. 9B illustrated on the right of the reflecting mirror 54).

FIG. 10A shows a single etalon type wavelength measuring apparatus. The output light from an optical fiber 61 passes a lens 62 generating a collimated beam which is directed to an etalon 63. The beam is multiple times reflected within the etalon 63, and thereafter received by a PD 64. The PD 64 detects signals depending on the wavelength (refer to wavelength-signal intensity characteristics as shown in FIG. 10B illustrated on the right of the PD 64).

FIG. 11 shows a two-etalon type wavelength measuring apparatus. The output light from an optical fiber 71 passes a lens 72 generating a collimated beam which is directed to a beamsplitter 73. The beamsplitter 73 splits the incident beam into a transmitted beam and a reflected beam. The transmitted beam is multiple times reflected within an etalon 74, and then directed to and received by a PD 75. The reflected beam is multiple times reflected within an etalon 76, and then directed to and received by a PD 77. The PDs 75 and 77 detect signals depending on the wavelength.

The etalons 74 and 76 have a thickness which is λ/8 different from each other, and one causes phase difference of π/2 compared to the other.

However, there are the following problems in the above-described wavelength measuring apparatus according to the earlier technology. The WDM coupler type and the BPF type wavelength measuring apparatus have a defect that the wavelength resolution is low. The interferometer type and the single etalon type wavelength measuring apparatus detect only a periodical signal, so that they have a defect that they are used only for wavelength locking, using a slope portion. Although the two-etalon type wavelength measuring apparatus obtains two signals, it has a disadvantage that it is unstable physically and also has a defect that it is difficult to be miniaturized.

### SUMMARY OF THE INVENTION

The present invention was developed in view of the above-described problems. Therefore, an object of the present invention is to provide a wavelength measuring apparatus which is capable of obtaining two signals by a single etalon, and which is physically stable and has high resolution so that the direction to which wavelength varies can be recognized in a wideband.

Another object of the present invention is to provide a wavelength tunable light source device for monitoring and correcting the oscillation wavelength of a light source.

In order to accomplish the above-described object, in one aspect of the present invention, a wavelength measuring apparatus comprises an optical fiber, and a lens receiving output beam from the optical fiber and generating a collimated beam. The wavelength measuring apparatus further comprises a wavelength discriminating section, an optical branching section, and first and second photo detectors. The wavelength discriminating section has a wavelength dependency, and the collimated beam passes the wavelength discriminating section. The wavelength discriminating section comprises a Fabry-Perot etalon. The optical branching section splits a beam into two beams and directs the two beams to the Fabry-Perot etalon. Each first and second photo detectors receives each split collimated beam which has transmitted the Fabry-Perot etalon. An optical axis of one split collimated beam is tilted with regard to an optical axis of another split collimated beam such that each period of amplitude of the two split collimated beams relatively shifts in phase difference of π/2.

According to the wavelength measuring apparatus, the Fabry-Perot etalon is employed for the wavelength discriminating section. The optical branching section splits a beam into two beams before the beam reaches the etalon, and then directs the two split beams to the etalon. An optical axis of one split beam is tilted with regard to an optical axis of the other split beam, so that each period of amplitude of the two split collimated beams which have transmitted the single etalon relatively shifts in phase difference of π/2.

As described above, the optical axis of one split beam is λ/8 tilted with regard to the optical axis of the other split beam (so that the optical path of one split beam is λ/8 longer than that of the other split beam), and the two split beams pass the single etalon. The first and second photo detectors receive the respective split beams, and detects the signals depending on the wavelengths of the beams. Therefore, physically stable two signals can be obtained. Further, the wavelength measuring apparatus has high resolution and can recognize direction to which wavelength varies in a wideband. Only the single etalon is used in the wavelength measuring apparatus, so that the configuration is simple compared to the two-etalon type wavelength measuring apparatus in earlier technology, and the wavelength measuring apparatus can be miniaturized. Moreover, the wavelength measuring apparatus requires only the single etalon, so that it is inexpensive.

The optical branching section may comprise a beamsplitter and a mirror. The collimated beam passes the beamsplitter which directs the passed collimated beam to the Fabry-Perot etalon. The beamsplitter also reflects the collimated beam toward a side. The mirror reflects a reflected beam from the beamsplitter toward the Fabry-Perot etalon. One of the beamsplitter and the mirror may be tilted, and the optical axis of one split collimated beam may be tilted with regard to the optical axis of another split collimated beam such that the phase difference of π/2 may be generated.

The optical branching section may comprise an optical fiber coupler for branching a beam from a light source in advance and for directing each branched beam to first and second optical fibers. The wavelength measuring apparatus may further comprise first and second lenses changing each output beam from the first and second optical fibers into a collimated beam. An optical axis of one collimated beam may be tilted with regard to an optical axis of another collimated beam such that the phase difference of π/2 may be generated.

One of the optical fibers and the optical fiber coupler may comprise a polarization maintaining fiber (PMF).

According to the wavelength measuring apparatus, the PMF may be used for the optical fiber or the optical fiber coupler, so that the detection errors due to the polarization dependency may be suppressed.

The wavelength measuring apparatus may further comprise a beamsplitter and a third photo detector. The beamsplitter reflects a part of the collimated beam sideward, and the beamsplitter is disposed on an optical path in a way to the Fabry-Perot etalon. The third photo detector receives reflected beam from the beamsplitter.

According to the wavelength measuring apparatus, the reflected beam with the beamsplitter may be received by the third photo detector in a way to the etalon, so that the detection errors for the wavelength due to the power fluctuation may be suppressed.

The wavelength measuring apparatus may further comprise an optical isolator preventing a return of a reflected beam on an optical path in a way to the Fabry-Perot etalon.

According to the wavelength measuring apparatus, the optical isolator can prevent the return of the reflected beam in front of the Fabry-Perot etalon.

In accordance with another aspect of the present invention, a wavelength tunable light source device, in which oscillation wavelength is tunable, comprises the above-described wavelength measuring apparatus built-in. The wavelength tunable light source device monitors and corrects the oscillation wavelength of a light source based on wavelength information from the wavelength measuring apparatus.

According to the wavelength tunable light source device with built-in wavelength measuring apparatus, based on the wavelength information from the built-in wavelength measuring apparatus, the wavelength tunable light source device can monitor and correct the oscillation wavelength of the light source.

### BRIEF DESCRIPTION OF THE DRAWINGS

The above and other objects, features and advantages of the invention will become more apparent from the following description taken in conjunction with the accompanying drawings wherein like references refer to like parts and wherein:

FIG. 1 is a schematic view of a configuration of a wavelength measuring apparatus according to the first embodiment of the present invention;

FIG. 2 is a schematic view of a configuration of a wavelength measuring apparatus according to the second embodiment of the present invention;

FIG. 3 is a schematic view of a configuration of a wavelength measuring apparatus according to the third embodiment of the present invention;

FIG. 4 is a schematic view of a configuration of a wavelength measuring apparatus according to the fourth modified embodiment of the present invention;

FIG. 5 is a schematic block diagram of a wavelength tunable light source device with built-in wavelength measuring apparatus, according to the fifth embodiment of the present invention;

FIG. 6 is a schematic block diagram of a wavelength tunable light source device with built-in wavelength measuring apparatus, according to the sixth embodiment of the present invention;

FIG. 7A is a schematic view of a configuration of a WDM coupler type wavelength measuring apparatus according to an earlier technology;

FIGS. 7B and 7C show wavelength-signal intensity characteristics detected by PDs of FIG. 7A;

FIG. 8A is a schematic view of a configuration of a BPF type wavelength measuring apparatus according to an earlier technology;

FIG. 8B shows wavelength-signal intensity characteristics detected by a PD of FIG. 8A;

FIG. 9A is a schematic view of a configuration of an interferometer type wavelength measuring apparatus according to an earlier technology;

FIG. 9B shows wavelength-signal intensity characteristics detected by a PD of FIG. 9A;

FIG. 10A is a schematic view of a configuration of a single etalon type wavelength measuring apparatus according to an earlier technology;

FIG. 10B shows wavelength-signal intensity characteristics detected by a PD of FIG. 10A; and

FIG. 11 is a schematic view of a configuration of a two-etalon type wavelength measuring apparatus according to an earlier technology.

### PREFERRED EMBODIMENTS OF THE INVENTION

Hereinafter, embodiments of the present invention will be explained in detail, referring to the drawings.

First Embodiment

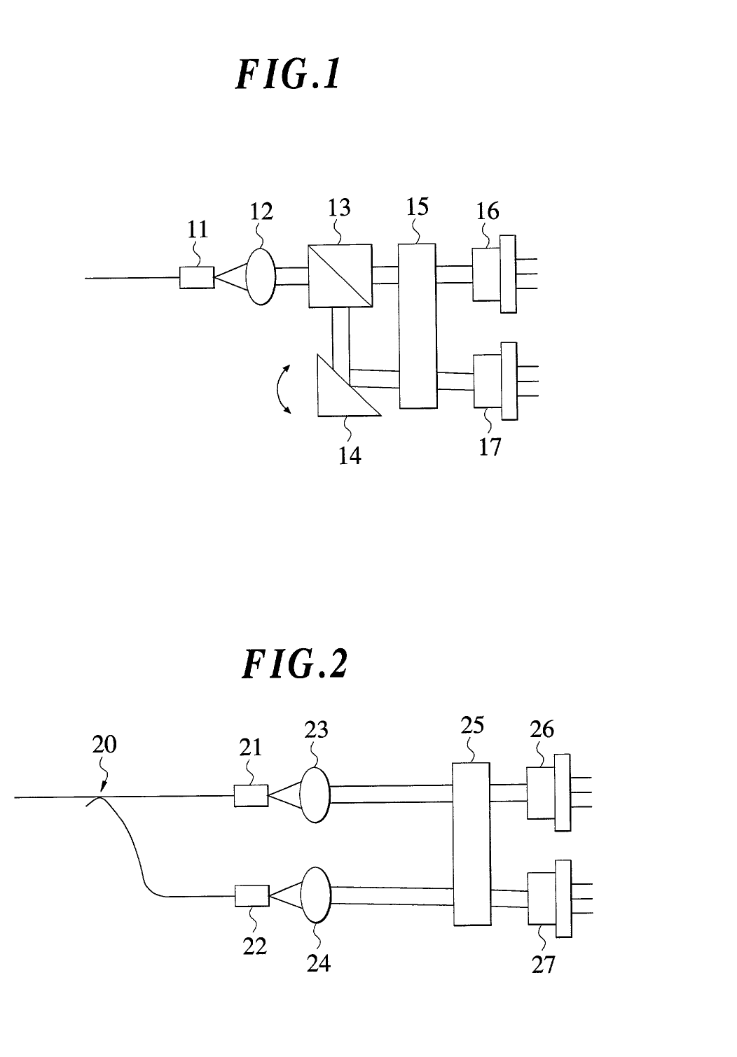

The wavelength measuring apparatus according to the first embodiment comprises, as shown in FIG. 1, an optical fiber 11, a lens 12, a beamsplitter 13, a mirror 14, a Fabry-Perot etalon (hereinafter, it is simply referred to as an etalon) 15, the first photo detector (the first PD) 16, and the second photo detector (the second PD) 17. The incident beam from a laser source (not shown) is output from the optical fiber 11. As the optical fiber 11, a polarization maintaining fiber (PMF) is preferable for curbing detection errors due to the polarization dependency. The lens 12 receives the output beam from the optical fiber 11 and changes the output beam to the collimated beam.

The beamsplitter 13 splits the collimated beam from the lens 12 into two beams, one of which is a transmitted beam passing the beamsplitter 13 and reaching the etalon 15, the other is a reflected beam reflected by the beamsplitter 13 at right angles with the transmitted beam. It is preferable that a branching ratio of the beam by the beamsplitter 13 is 50:50. The mirror 14 reflects the beam reflected by the beamsplitter 13 at about right angles and inputs the beam to the etalon 15. The beamsplitter 13 and the mirror 14 make up the light branching section splitting the beam into two beams.

The etalon 15 has plane parallel plates of glass or prism with reflecting film. The incident beam is multiple times reflected within the etalon 15, and then leaves the etalon 15. The first PD 16 receives one of the beams transmitting the etalon 15, and detects the signal depending on the wavelength. The second PD 17 receives the other beam transmitting the etalon 15, and detects the signal depending on the wavelength.

The angle of the beamsplitter 13 or the mirror 14 is adjusted so that the optical axis of the collimated beam directed to the etalon 15 is slightly tilted. Concretely, the optical axis of the collimated beam from the mirror 14 toward etalon 15 is slightly tilted so that the optical path (optical path length) will be λ/8 longer in a portion corresponding to a thickness of the etalon 15, with regard to an optical axis of the collimated beam transmitting the beamsplitter 13 and reaching the etalon 15. If the thickness of the plate of the etalon 15 is too thin, the wavelength resolution becomes low, while if the thickness of the plate is too thick, errors will arise when the mode hopping occurs. Therefore, it is preferable that the thickness of the plate is set so that the free spectral range (FSR) will be about 0.1 nm to 0.5 nm. A specific thickness of the plate is, for example, about 1.5 mm to 8 mm, when the refractive index of the etalon is 1.5.

According to the wavelength measuring apparatus in the first embodiment, the beam transmitting the beamsplitter 13, and the beam reflected by the beamsplitter 13 and then further reflected by the mirror 14 are input to the etalon 15, respectively. The beams are multiple times reflected within the etalon 15, and then leave the etalon 15. The beams from the etalon 15 are received by the first PD 16 and the second PD 17, respectively. By receiving the beams, the first PD 16 and the second PD 17 detect signals having periodical amplitude proximate to the sine wave in the wavelength-signal intensity characteristics, which are not shown. It is preferable that the signals are close to the sinusoidal characteristics, and it is preferable that the reflectance of the reflecting film on the both plates of the etalon 15 is optimized previously. Particularly, the detected signal of the second PD 17 is π/2 phase shifted with regard to the detected signal of the first PD 16.

Although the periodical amplitude can realize the high wavelength resolution, the resolution for the peaks and valleys of the sinusoidal characteristics is low with the single signal alone, so that it is difficult to recognize the direction to which wavelength varies in a wideband. On the other hand, the two signals which are π/2 phase shifted are used in the embodiment. For example, as the principle of an encoder used in a servomotor, the two signals cover the peaks and valleys of each other's signals. As a result, stable resolution and recognition of the direction to which wavelength varies can be achieved.

According to the wavelength measuring apparatus using the etalon 15, resolution is high, and the direction to which wavelength varies can be recognized in the wideband. Only the single etalon 15 is used in the wavelength measuring apparatus, so that the configuration is simple compared to the two-etalon type wavelength measuring apparatus in earlier technology. Further, two signals can be obtained from the single etalon 15, so that the wavelength measuring apparatus is stable physically and can be miniaturized. Moreover, the wavelength measuring apparatus requires only the single etalon 15, so that it is inexpensive.

Second Embodiment

The wavelength measuring apparatus according to the second embodiment comprises, as shown in FIG. 2, an optical fiber coupler 20, the first optical fiber 21, the second optical fiber 22, the first lens 23, the second lens 24, a Fabry-Perot etalon (hereinafter, it is simply referred to as an etalon) 25, the first photo detector (the first PD) 26, and the second photo detector (the second PD) 27. The incident beam from a laser source which is not shown is split with the optical fiber coupler (optical branching section) 20 into two beams. As the optical fiber coupler 20, a polarization maintaining fiber (PMF) is preferable for curbing detection errors due to the polarization dependency.

The two split beams from the optical fiber coupler 20 pass the first and the second optical fibers 21 and 22, respectively. It is preferable that a branching ratio of the beam by the optical fiber coupler is 50:50. The first lens 23 receives the output beam from the first optical fiber 21, and the second lens 24 receives the output beam from the second optical fiber 22. The first and second lenses 23 and 24 generate the collimated beams, respectively.

The etalon 25 has plane parallel plates of glass or prism with reflecting film. The incident beam from the lens 23 or 24 is multiple times reflected within the etalon 25, and the multiple times reflected beam leaves the etalon 25. The first PD 26 receives one of the beams transmitting the etalon 25, and detects the signal depending on the wavelength. The second PD 27 receives the other beam transmitting the etalon 25, and detects the signal depending on the wavelength.

In the wavelength measuring apparatus, the optical axis of the collimated beam passing the second lens 24 and directed to the etalon 25 is slightly tilted. Concretely, the optical axis of the collimated beam from the second lens 24 toward the etalon 25 is slightly tilted so that the optical path (optical path length) will be λ/8 longer in a portion corresponding to a thickness of the etalon 25, with regard to an optical axis of the collimated beam transmitting the first lens 23 and reaching the etalon 25. Alternatively, the optical axis of the collimated beam passing the first lens 23 and input to the etalon 25 may be slightly tilted. In this case, the optical axis of the collimated beam from the first lens 23 toward the etalon 25 is slightly tilted so that the optical path will be λ/8 longer in the portion corresponding to the thickness of the etalon 25, with regard to the optical axis of the collimated beam transmitting the second lens 24 and reaching the etalon 25.

According to the wavelength measuring apparatus in the second embodiment, the beam passing the first lens 23 and the beam passing the second lens 24 are directed to and input to the etalon 25. The beams are multiple times reflected within the etalon 25, and then leave the etalon 25. The beams from the etalon 25 are received by the first PD 26 and the second PD 27, respectively. By receiving the beams, the first PD 26 and the second PD 27 detect signals having the sinusoidal characteristics in the wavelength signal intensity characteristics which is not shown. Particularly, the detected signal of the second PD 27 is π/2 phase shifted with regard to the detected signal of the first PD 26.

Third Embodiment

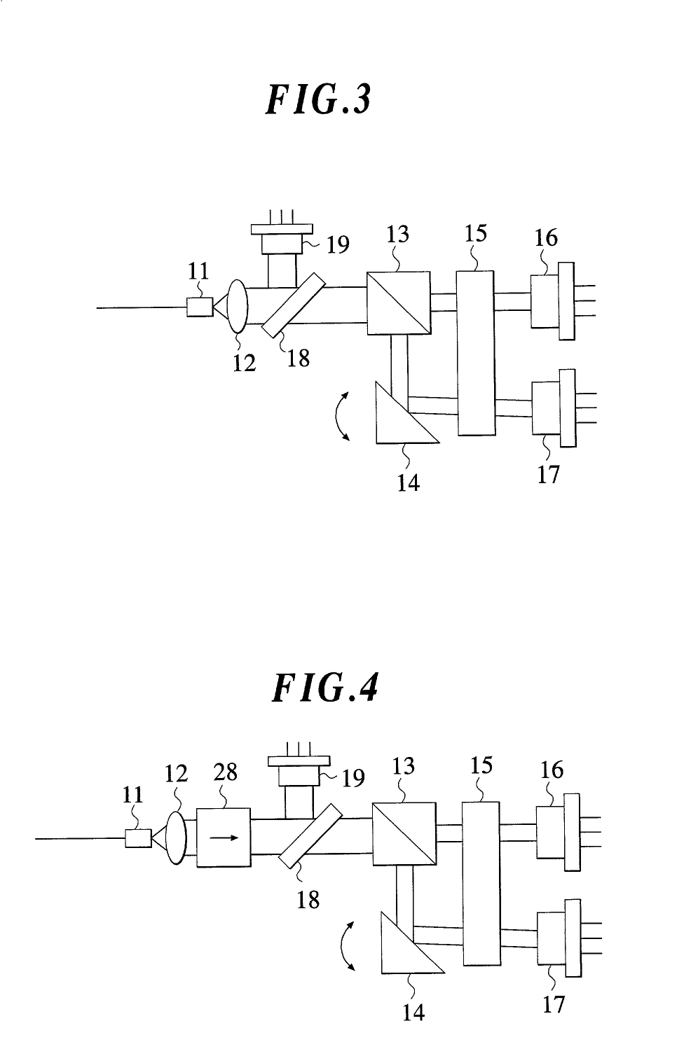

In the wavelength measuring apparatus in the first or second embodiment, a beamsplitter may be disposed additionally on the optical path in front of the etalon 15 or 25. For example, as shown in FIG. 3, a wavelength measuring apparatus according to a third embodiment has the same structure as the wavelength measuring apparatus in the first embodiment, except for a beamsplitter 18 and a photo detector (the third PD) 19. To structural members or the like corresponding to those of the first embodiment shown in FIG. 1, the same reference numerals are attached, and the detailed explanation for them is properly omitted.

Preferably, the beamsplitter 18 is disposed between the lens 12 and the beamsplitter 13. The beamsplitter 18 reflects a part of the collimated beam from the lens 12 and directs to the third PD 19. The third PD 19 receives the reflected beam and detects power fluctuation. Preferably, the beamsplitter 18 for detecting the power fluctuation directs a part of the collimated beam from the lens 12 into the third PD 19 with reflectance of about 5% to 50%.

Fourth Embodiment

Similarly, an optical isolator may be disposed additionally on the optical path in front of the etalon 15 or 25. As shown in FIG. 4, a wavelength measuring apparatus according to a fourth embodiment has the same structure as the wavelength measuring apparatus in the third embodiment, except for an optical isolator 28. To structural members or the like corresponding to those of the third embodiment shown in FIG. 3, the same reference numerals are attached, and the detailed explanation for them is properly omitted.

The optical isolator 28 may be disposed between the lens 12 and the beamsplitter 18, and prevent the return of the reflected beam.

Fifth Embodiment

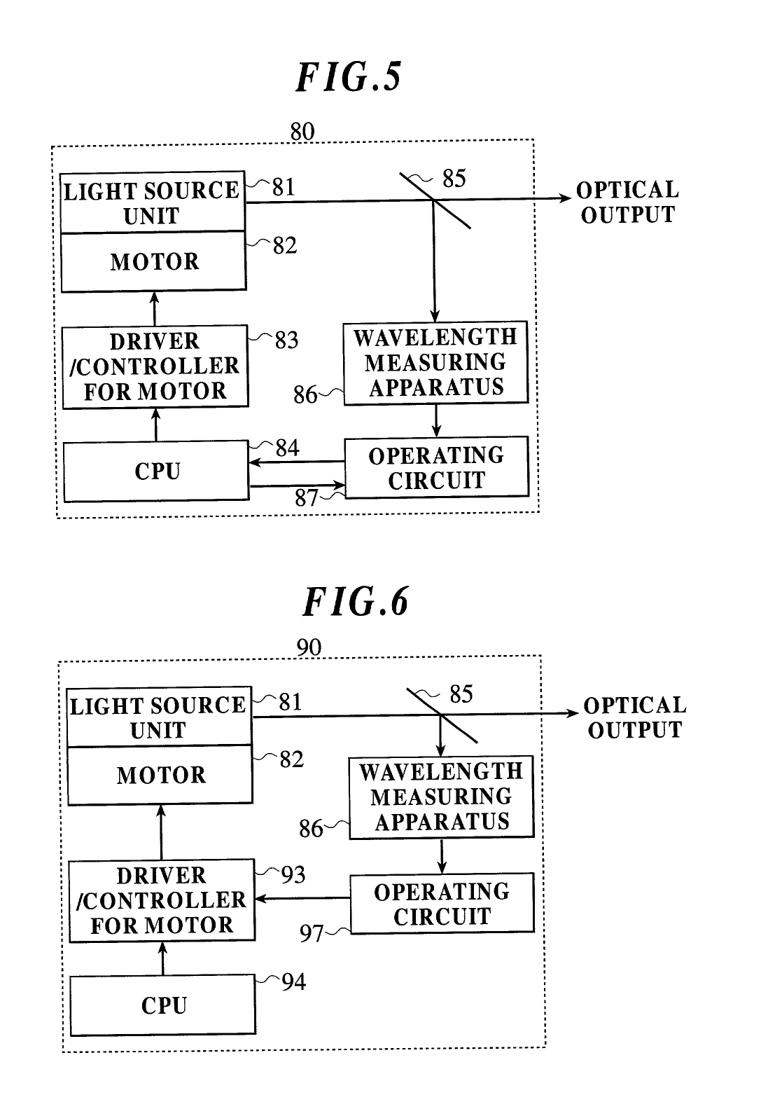

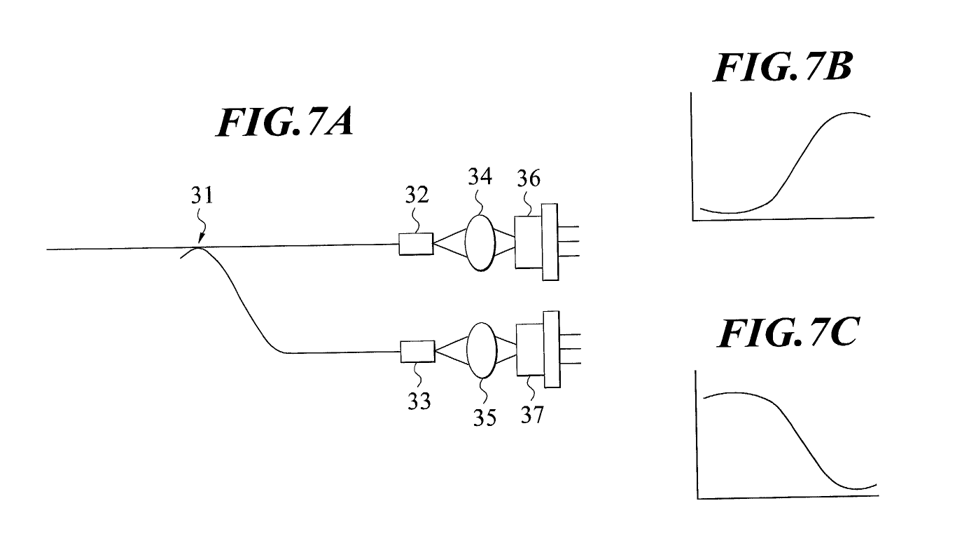

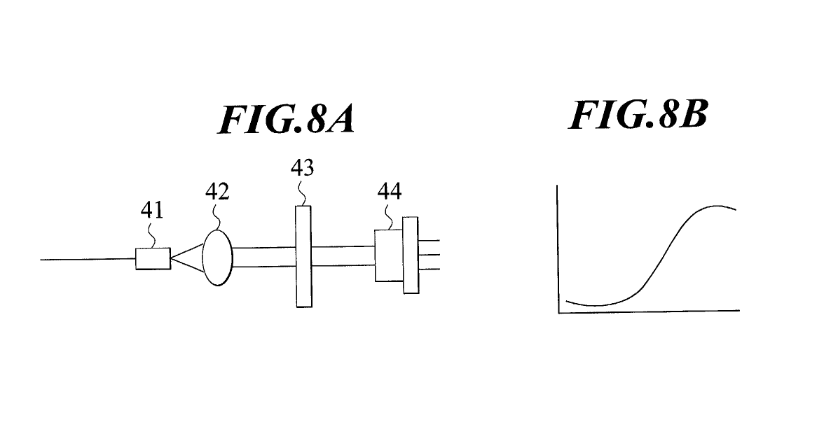

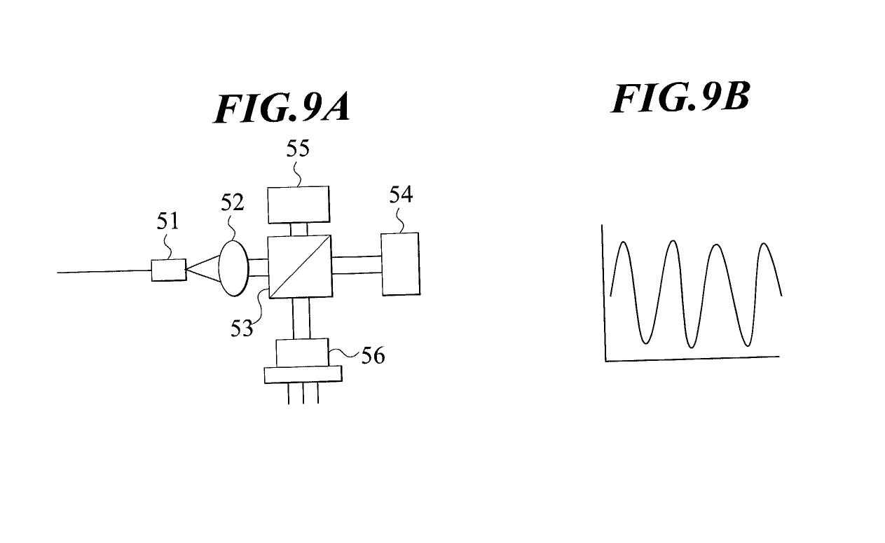

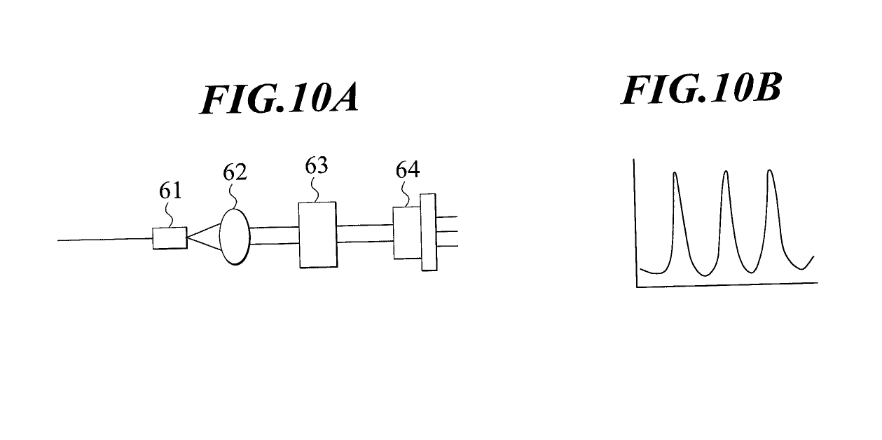

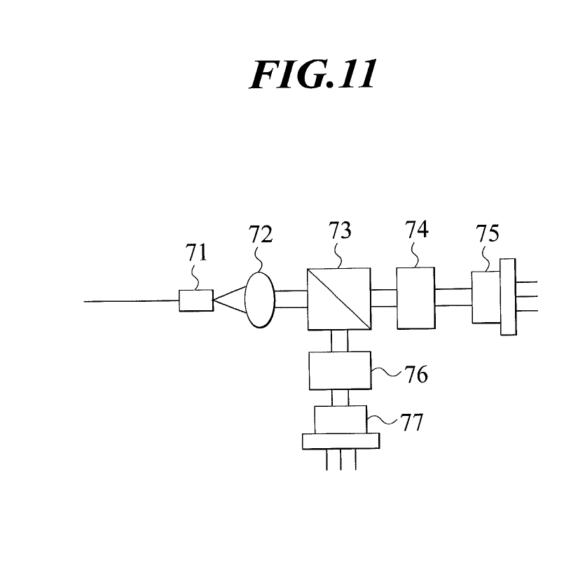

Each wavelength measuring apparatus using the etalon 15 or 25 according to each embodiment of the present invention may be integrated into a wavelength tunable light source device. The wavelength tunable light source device 80 according to the fifth embodiment, as shown in FIG. 5., comprises a light source unit 81, a motor (wavelength tunable means) 82, a driver/controller for motor 83, a CPU 84, a beamsplitter 85, a wavelength measuring apparatus 86, and an operating (calculation) circuit 87. The light source unit 81 and the motor configure a wavelength tunable light source. The wavelength measuring apparatus 86 is one selected from among the wavelength measuring apparatus of the first to fourth embodiments of the present invention.

At first, in the CPU 84, data for emitting a beam with desired wavelength is set, and its data signal is outputted from the CPU 84 to the driver/controller for motor 83. The driver/controller for motor 83 further outputs the data signal to the motor 82. Then, the motor 82 actuates the light source unit 81 on the basis of the signal inputted from the driver/controller for motor 83. Thereby, a beam with desired wavelength is emitted from the light source unit 81.

A part of the beam emitted from the light source unit 81 is reflected in the beam splitter 85, and directed to the wavelength measuring apparatus 86. Thereby, wavelength information of two signals relatively having a phase difference of π/2 is obtained by the wavelength measuring apparatus 86. The obtained wavelength information is inputted in the operating circuit 87.

The CPU 84 monitors the operating circuit 87, and outputs a signal of correcting wavelength to the driver/controller for motor 83 on the basis of the operation result in the operating circuit 87. That is, for example, when an error is caused in the wavelength information obtained by the wavelength measuring apparatus 86, the CPU 84 first recognizes the error by monitoring the operating circuit 87, and then outputs a signal to the driver/controller for motor 83 so that the error will be corrected by the motor 82 actuating the light source unit 81.

Then, the driver/controller for motor 83 outputs a signal for correcting the error to the motor 82 according to the signal from the CPU 84. Thereby, the light source unit 81 is actuated, so that the wavelength is corrected and a beam with desired wavelength is emitted again.

Thus, in the wavelength tunable light source device 80, the oscillation wavelength of the wavelength tunable light source can be corrected by making the CPU 84 monitor the wavelength information obtained by the wavelength measuring apparatus 86.

Sixth Embodiment

FIG. 6 shows another wavelength tunable light source device according to the sixth embodiment. As shown in FIG. 6, the wavelength tunable light source device 90 has the same structure as the wavelength tunable light source device in the fifth embodiment, except for a driver/controller for motor 93, a CPU 94, and an operating (calculation) circuit 97. To structural members, or the like corresponding to those of the fifth embodiment shown in FIG. 5, the same reference numerals are attached, and the detailed explanation for them is properly omitted.

At first, as the same as the above-described wavelength tunable light source device 80, data for emitting a beam with desired wavelength is set in the CPU 94. Thereby, a beam with desired wavelength is emitted from the light source unit 81.

A part of the beam emitted from the light source unit 81 is reflected in the beam splitter 85 and directed to the wavelength measuring apparatus 86, so that wavelength information of two signals relatively having a phase difference of π/2 is obtained by the wavelength measuring apparatus 86. The obtained wavelength information is inputted in the operating circuit 97.

Here, in the operating circuit 97, a predetermined operating program is stored. This is for detecting an error of the wavelength information obtained by the wavelength measuring apparatus 86. When the operation result is less/more than a predetermined value, the operating circuit 97 recognizes that an error is caused in the wavelength information obtained by the wavelength measuring apparatus 86. Then, the operating circuit 97 outputs a signal for correcting the error to the driver/controller for motor 93.

The driver/controller for motor 93 outputs a signal to the motor 82 according to the signal from the operating circuit 97. Thereby, the wavelength is corrected.

Thus, in the wavelength tunable light source device 90, oscillation wavelength of the wavelength tunable light source can be corrected on the basis of the wavelength information obtained by the wavelength measuring apparatus 86 according to the first to fourth embodiment.

From the foregoing description, one skilled in the art can easily ascertain the essential characteristics of this invention, and without departing from the spirit and scope thereof, can make various changes and modifications of the invention to adapt it to various usage and conditions.

The entire disclosure of Japanese Patent Application No. 2000-398583 filed on Dec. 27, 2000 including specification, claims, drawings and summary are incorporated herein by reference in its entirety.

What is claimed is:

1. A wavelength measuring apparatus comprising:
an optical fiber;
a lens receiving output beam from the optical fiber, and generating a collimated beam;
a wavelength discriminating section having a wavelength dependency, the collimated beam passing the wavelength discriminating section, and the wavelength discriminating section comprising a Fabry-Perot etalon;
an optical branching section splitting a beam into two beams and directing the two beams to the Fabry-Perot etalon; and
first and second photo detectors, each receiving each split collimated beam which has transmitted the Fabry-Perot etalon;
wherein an optical axis of one split collimated beam is tilted with regard to an optical axis of another split collimated beam such that each period of amplitude of the two split collimated beams relatively shifts in phase difference of π/2.

2. The wavelength measuring apparatus as claimed in claim 1, wherein the optical branching section comprises:
a beamsplitter which the collimated beam passes, and directs the passed collimated beam to the Fabry-Perot etalon, and which reflects the collimated beam toward a side; and
a mirror which reflects a reflected beam from the beamsplitter toward the Fabry-Perot etalon, and
wherein one of the beamsplitter and the mirror is tilted, and the optical axis of one split collimated beam is tilted with regard to the optical axis of another split collimated beam such that the phase difference of π/2 is generated.

3. The wavelength measuring apparatus as claimed in claim 1, wherein the optical branching section comprises an optical fiber coupler for branching a beam from a light source in advance and for directing each branched beam to first and second optical fibers,
the wavelength measuring apparatus comprises first and second lenses changing each output beam from the first and second optical fibers into a collimated beam, and
wherein an optical axis of one collimated beam is tilted with regard to an optical axis of another collimated beam such that the phase difference of π/2 is generated.

4. The wavelength measuring apparatus as claimed in claim 1, wherein the optical fiber comprises a polarization maintaining fiber.

5. The wavelength measuring apparatus as claimed in claim 3, wherein one of the optical fibers and the optical fiber coupler comprises a polarization maintaining fiber.

6. The wavelength measuring apparatus as claimed in claim 1, further comprising:
a beamsplitter reflecting a part of the collimated beam sideward, the beamsplitter being disposed on an optical path in a way to the Fabry-Perot etalon; and
a third photo detector receiving reflected beam from the beamsplitter.

7. The wavelength measuring apparatus as claimed in claim 1, further comprising:
an optical isolator preventing a return of a reflected beam on an optical path in a way to the Fabry-Perot etalon.

8. A wavelength tunable light source device with built-in wavelength measuring apparatus, in which oscillation wavelength is tunable, the wavelength tunable light source device comprising:
a wavelength measuring apparatus built-in, which comprises:
an optical fiber;
a lens receiving output beam from the optical fiber, and generating a collimated beam;
a wavelength discriminating section having a wavelength dependency, the collimated beam passing the wavelength discriminating section, and the wavelength discriminating section comprising a Fabry-Perot etalon;
an optical branching section splitting a beam into two beams and directing the two beams to the Fabry-Perot etalon; and
first and second photo detectors, each receiving each split collimated beam which has transmitted the Fabry-Perot etalon;
wherein an optical axis of one split collimated beam is tilted with regard to an optical axis of another split collimated beam such that each period of amplitude of the two split collimated beams relatively shifts in phase difference of π/2,
wherein the wavelength tunable light source device monitors and corrects the oscillation wavelength of a light source based on wavelength information from the wavelength measuring apparatus.

9. A wavelength measuring apparatus comprising:
a wavelength discriminating section having a wavelength dependency, a collimated beam passing the wavelength discriminating section, and the wavelength discriminating section comprising a Fabry-Perot etalon;
an optical branching section splitting a beam into two beams and directing the two beams to the Fabry-Perot etalon; and
first and second photo detectors, each receiving each split collimated beam which has transmitted the Fabry-Perot etalon, and detecting a signal depending on wavelength of the split collimated beam;
wherein an optical axis of one split collimated beam is tilted with regard to an optical axis of another split collimated beam such that each amplitude period of the two split collimated beams relatively shifts in phase difference of π/2.
